(19) United States
(12) Patent Application Publication
(10) Pub. No.: US 2024/0339721 A1
(43) Pub. Date: Oct. 10, 2024

(54) BATTERY CASE

(71) Applicant: Microvast Power Systems Co., Ltd., Huzhou (CN)

(72) Inventors: Wanyi YANG, Huzhou (CN); Heng ZHAO, Huzhou (CN); Bin LI, Huzhou (CN); Ningqiang XIAO, Huzhou (CN); Cheng ZHONG, Huzhou (CN)

(73) Assignee: Microvast Power Systems Co., Ltd., Huzhou (CN)

(21) Appl. No.: 18/631,083

(22) Filed: Apr. 10, 2024

(30) Foreign Application Priority Data
Apr. 10, 2023 (CN) 202320862047.3

(51) Int. Cl. H01M 50/367; H01M 50/383

(52) U.S. Cl. CPC H01M 50/367; H01M 50/383

(57) ABSTRACT

A battery case includes a case body, a first baffle plate and a baffle cover. A gas exhaust channel is obliquely penetrated through a wall of the case body. The first baffle plate and the baffle cover are connected to the outer surface of the wall of the case body. The gas exhaust channel includes a gas inlet and a gas outlet. The first baffle plate is located on one side of the gas outlet away from the gas inlet. The baffle cover covers the gas outlet and the first baffle plate. There is a gas passage between the inner surface of the baffle cover and the first baffle plate. The baffle cover is provided with a gas exhaust opening. The gas inside the case body can be discharged out from the gas exhaust opening after flowing sequentially through the gas exhaust channel and the gas passage.

### BACKGROUND OF THE APPLICATION

### Field of the Application

The present application relates to the technical field of battery technology, and in particular, to a battery case for energy storage.

### Description of Related Art

When there is a failure of the battery pack inside the battery case, a large amount of gas will be generated instantly, and the pressure inside the relatively closed battery case will suddenly rise, which is prone to explosion. At this moment, the gas and flame inside the battery case will directly spray out from the battery case into the external environment. Once the gas containing flame is sprayed out to the outside of the battery case, it is easy to endanger the safety of nearby personnel and property.

Currently, to solve the above problems, an explosion-proof valve is usually installed on the battery case as a structure for explosion-proof and gas exhausting. When the battery pack inside the battery case produces gas or explodes due to failure, the high-pressure gas generated by the battery pack causes the explosion-proof valve to enter the explosion-proof state, that is, the explosion-proof valve opens, allowing the high-pressure gas to be discharged through the explosion-proof valve, causing a rapid decrease in gas pressure inside the battery case, and preventing the battery case from exploding due to excessive internal pressure.

Some battery cases used for energy storage have slightly lower requirements for water proofing and dust prevention, but higher requirements for fire and explosion prevention. The explosion-proof valve in existing technology usually enters the explosion-proof state until the internal gas pressure of the battery case reaches an explosion-proof threshold, therefore the gas exhausting is not timely enough. Meanwhile, when there is a failure of the battery pack inside the battery case, it often burns, and the gas carrying flame will be quickly discharged from the explosion-proof valve under the explosion-proof state, which is easy to cause harm to nearby personnel and property.

### BRIEF SUMMARY OF THE APPLICATION

The object of the present application is to provide a battery case that can not only exhaust gas in real-time to balance the pressure between the inside and outside of the case body and prevent explosion, but also prevent or delay the flame from escaping when the battery pack in the battery case catches fire or explodes due to abnormalities, thereby facilitating the timely transfer of nearby personnel or property.

An embodiment of the present application provides a battery case comprising a case body, a first baffle plate and a baffle cover, wherein a gas exhaust channel is obliquely penetrated through a wall of the case body, and the first baffle plate and the baffle cover are both connected to an outer surface of the wall of the case body;

along a gas exhaust direction of the gas exhaust channel, the gas exhaust channel comprises a gas inlet located upstream and a gas outlet located downstream, and the first baffle plate is located on one side of the gas outlet away from the gas inlet;

the baffle cover covers the gas outlet and the first baffle plate, and there is a gas passage between an inner surface of the baffle cover and the first baffle plate; the baffle cover is provided with a gas exhaust opening, and the gas exhaust opening is located on one side of the first baffle plate away from the gas inlet; gas inside the case body is able to be discharged out from the gas exhaust opening after flowing sequentially through the gas exhaust channel and the gas passage.

In an achievable way, the baffle cover comprises an outer cover plate and a side cover plate, the outer surface of the wall of the case body is spaced from the outer cover plate, the side cover plate is connected to the outer cover plate, and the outer cover plate is connected to the outer surface of the wall of the case body through the side cover plate; one side of the first baffle plate away from the case body abuts against an inner surface of the outer cover plate.

In an achievable way, the battery case has a first direction, wherein the first direction is perpendicular to the gas exhaust direction of the gas exhaust channel, and the first direction is parallel to the outer surface of the wall of the case body on which the first baffle plate is located;

along the first direction, the gas passage is formed between an inner surface of the side cover plate and the first baffle plate.

In an achievable way, the battery case has a first direction, wherein the first direction is perpendicular to the gas exhaust direction of the gas exhaust channel, and the first direction is parallel to the outer surface of the wall of the case body on which the first baffle plate is located; along the first direction, two opposite ends of the first baffle plate extend beyond two opposite lateral sides of the gas outlet, respectively.

In an achievable way, along the first direction, the first baffle plate comprises a flat portion and two sloping portions connected to two opposite ends of the flat portion, the flat portion extends along the first direction, and an angle formed between the sloping portion and the flat portion is an obtuse angle, the obtuse angle is located on one side of the first baffle plate near the gas outlet.

In an achievable way, the battery case has a first direction, wherein the first direction is perpendicular to the gas exhaust direction of the gas exhaust channel, and the first direction is parallel to the outer surface of the wall of the case body on which the first baffle plate is located;

the case body is provided with multiple gas exhaust channel groups, the multiple gas exhaust channel groups are arranged and spaced apart along the first direction, each gas exhaust channel group comprises one first baffle plate and at least one gas exhaust channel; the first baffle plates of adjacent gas exhaust channel groups are spaced apart from each other.

In an achievable way, the number of the baffle cover is one or multiple, and each baffle cover correspondingly covers one gas exhaust channel group or multiple adjacent gas exhaust channel groups.

In an achievable way, the battery case has a second direction, wherein the second direction is perpendicular to the first direction, and the second direction is parallel to the outer surface of the wall of the case body on which the first baffle plate is located; each gas exhaust channel group comprises multiple gas exhaust channels, and the multiple gas exhaust channels in each gas exhaust channel group are sequentially arranged along the second direction; along the gas exhaust direction of the gas exhaust channel, the first baffle plate is arranged at the most downstream gas exhaust channel of the gas exhaust channel group.

In an achievable way, the battery case further comprises a second baffle plate, and the second baffle plate is arranged between adjacent two gas exhaust channels of the gas exhaust channel group.

In an achievable way, the gas exhaust channel is provided on a side wall of the case body, and along the gas exhaust direction of the gas exhaust channel, and the gas exhaust channel is sloped downwards.

In an achievable way, the first baffle plate is located under the gas outlet of the gas exhaust channel, and the gas exhaust opening is located at the bottom of the baffle cover.

In an achievable way, a guiding tab is located inside the case body and obliquely connected to an inner surface of the side wall of the case body, and the gas exhaust channel is formed along the guiding tab.

In an achievable way, the guiding tab extends obliquely from an inner surface of the side wall of the case body towards a top wall of the case body.

In an achievable way, the side walls on opposite sides of the case body are provided with the gas exhaust channel to form a gas exhausting structure on both sides of the battery case.

An embodiment of the present application provides a battery case comprising a case body, a first baffle plate and a baffle cover, wherein the first baffle plate and the baffle cover are both located outside the case body and are both connected to an outer surface of the side wall of the case body, a guiding tab is located in an inner chamber of the case body and obliquely connected to an inner surface of the side wall of the case body, a gas exhaust channel is formed along the guiding tab and is penetrated through the side wall of the case body, the gas exhaust channel communicates the inner chamber of the case body with an inner cavity of the baffle cover;

along a gas exhaust direction of the gas exhaust channel, the gas exhaust channel comprises a gas inlet located upstream and a gas outlet located downstream, and the first baffle plate is located on one side of the gas outlet away from the gas inlet;

the baffle cover covers the gas outlet and the first baffle plate, the baffle cover comprises an outer cover plate, the outer surface of the side wall of the case body is spaced from the outer cover plate, the baffle cover is provided with a gas exhaust opening, and the gas exhaust opening is located on one side of the first baffle plate away from the gas inlet; an inner side of the first baffle plate is connected to the outer surface of the side wall of the case body, while an outer side of the first baffle plate away from the case body abuts against an inner surface of the outer cover plate;

wherein gas inside the case body flows along the gas exhaust channel to enter the inner cavity of the baffle cover, then collides with the first baffle plate and turns towards two opposite ends of the first baffle plate, and then flows towards the gas exhaust opening to be finally discharged out from the gas exhaust opening.

In an achievable way, the guiding tab extends obliquely from the inner surface of the side wall of the case body towards a top wall of the case body.

In an achievable way, along a height direction of the battery case, the first baffle plate is located under the gas outlet of the gas exhaust channel, and the gas exhaust opening is located under the first baffle plate.

In an achievable way, the baffle cover further includes at least one side cover plate connected to the outer cover plate, the outer cover plate is connected to the outer surface of the side wall of the case body through the side cover plate.

In an achievable way, there are multiple gas exhaust channels provided on the side wall of the case body, the multiple gas exhaust channels are arranged and spaced apart along a height direction of the battery case, the battery case further comprises a second baffle plate, the second baffle plate is arranged between adjacent two gas exhaust channels, an inner side of the second baffle plate is connected to the outer surface of the side wall of the case body, while an outer side of the second baffle plate away from the case body abuts against the inner surface of the outer cover plate; the first baffle plate is located under the second baffle plate, and the gas exhaust opening is located under the first baffle plate.

In an achievable way, the first baffle plate is located under the lowest gas exhaust channel of the multiple gas exhaust channels.

In an achievable way, each gas exhaust channel extends along a horizontal direction, the multiple gas exhaust channels are arranged and spaced apart sequentially in a vertical direction; each of the first baffle plate and the second baffle plate extends in the horizontal direction.

The battery case is provided with a gas exhaust channel which is obliquely formed on the case body. The first baffle plate and the baffle cover are arranged outside the gas exhaust channel. Along the gas exhaust direction of the gas exhaust channel, the first baffle plate is located on one side of the gas outlet of the gas exhaust channel away from the gas inlet. There is a gas passage between the inner surface of the baffle cover and the first baffle plate. The gas exhaust opening formed on the baffle cover is located on one side of the first baffle plate away from the gas inlet. When the gas inside the case body is discharged, the gas inside the case body first flows to the first baffle plate located on one side of the gas outlet away from the gas inlet under the guidance of the gas exhaust channel. The gas exhaust opening formed on the baffle cover is located on one side of the first baffle plate away from the gas inlet. After the gas inside the case body flows to the first baffle plate, the gas changes direction due to blockage of the first baffle plate, then changes direction by the inner surface of the baffle cover, and then flows through the gas passage to the gas exhaust opening on the baffle cover. In summary, under the blockage of the first baffle plate and the baffle cover, a tortuous gas flow channel can be formed inside the baffle cover, and the gas inside the case body can be discharged in real-time through this gas flow channel to balance the pressure inside and outside the case body and prevent explosion. When the battery pack inside the battery case catches fire or explodes due to abnormalities, this tortuous gas flow channel is beneficial for extinguishing the flame, preventing or delaying the flame from escaping, and facilitating the timely transfer of nearby personnel or property.

### BRIEF DESCRIPTION OF THE DRAWINGS

FIG. 1 is a three-dimensional structural diagram of the battery case by removing the bottom cover in the embodiment of the present application.

FIG. 2 is an exploded, schematic diagram of FIG. 1.

FIG. 3 is a front view of FIG. 1.

FIG. 4 is a schematic diagram of FIG. 3 with the baffle covers removed.

FIG. 5 is a partial perspective view of FIG. 3.

FIG. 6 is a cross-sectional schematic diagram of FIG. 5 along the A-A position.

FIG. 7 is a three-dimensional structural diagram of the baffle cover in the embodiment of the present application.

FIG. 8 is a schematic diagram of the flow direction of gas from the case body to the inside of the baffle cover through the gas exhaust channel in the embodiment of the present application.

FIG. 9 is a schematic diagram of the flow direction of gas from the gas exhaust channel to the gas exhaust opening in the embodiment of the present application.

FIG. 10 is a three-dimensional structural diagram of the baffle cover in another embodiment of the present application.

In the figures: 1—case body, 10—gas exhaust channel group, 11—gas exhaust channel, 12—side wall, 13—guiding tab, 14—top wall, 111—gas inlet, 112—gas outlet, 2—first baffle plate, 21—flat portion, 22—sloping portion, 221—connecting end, 222—protruding end, 3—baffle cover, 30—gas passage, 31—outer cover plate, 32—side cover plate, 321—gas exhaust opening, 4—second baffle plate, 5—inner chamber, 6—inner cavity.

### DETAILED DESCRIPTION OF THE APPLICATION

The following will provide a further detailed description of the specific implementations of the present application in conjunction with the accompanying drawings and embodiments. The following embodiments are used to illustrate the present application, but are not intended to limit the scope of the present application.

The terms “first”, “second”, “third”, “fourth”, etc. (if any) in the specification and claims of the present application are only used to distinguish similar objects, and are not intended to be used to describe a specific sequence or order.

The terms “up”, “down”, “left”, “right”, “front”, “back”, “top”, “bottom” (if any) mentioned in the specification and claims of the present application are defined based on the position of the structure in the figures and the position between the structures in the figures, only for the clarity and convenience of expressing the technical solution. It should be understood that the use of these directional words should not limit the scope of protection in the present application.

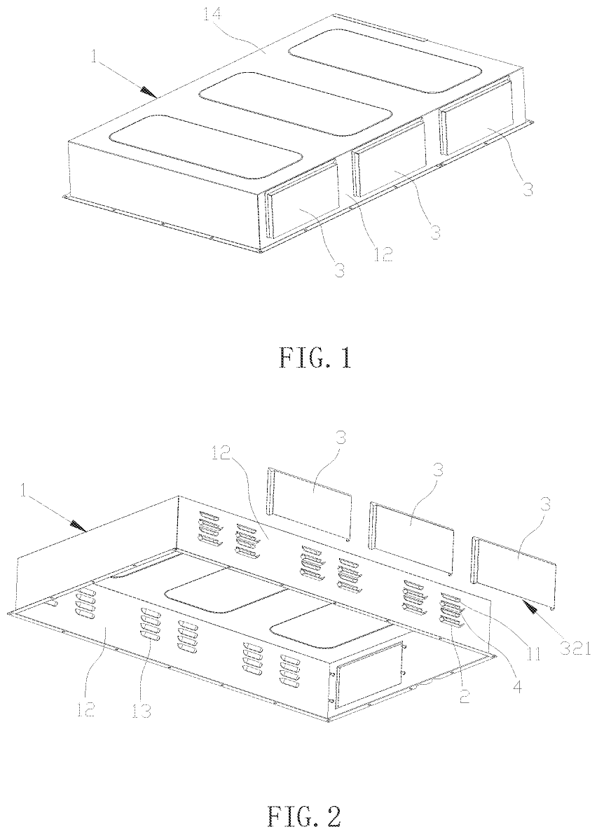

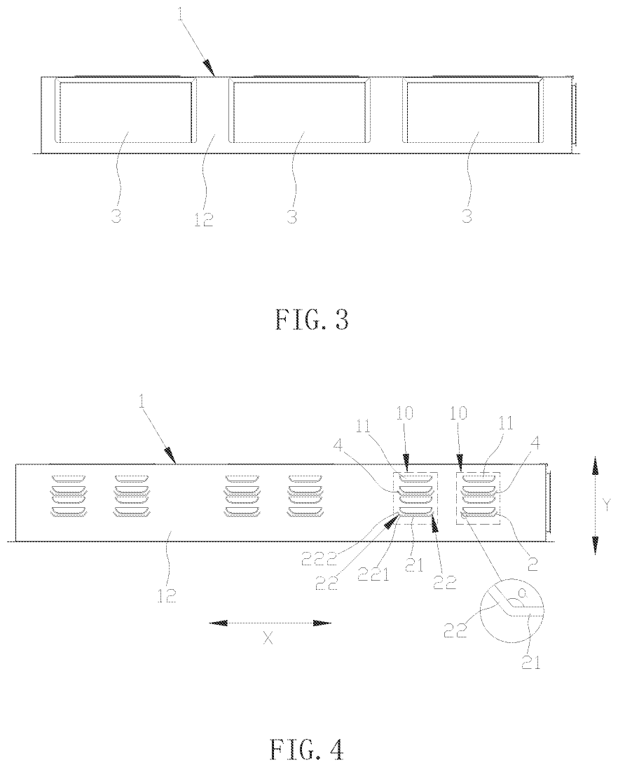

Referring to the embodiment shown in FIGS. 1 to 6, the battery case provided in the present application includes a case body 1, a first baffle plate 2 and a baffle cover 3. A gas exhaust channel 11 is obliquely penetrated through a wall of the case body 1. The first baffle plate 2 and the baffle cover 3 are both located outside the case body 1. The first baffle plate 2 and the baffle cover 3 are both connected to the outer surface of the wall of the case body 1. In this embodiment, the gas exhaust channel 11 is obliquely penetrated through a side wall 12 of the case body 1, and the first baffle plate 2 and the baffle cover 3 are both connected to the outer surface of the side wall 12 of the case body 1. However, in other embodiments not shown, the gas exhaust channel 11 may also be obliquely penetrated through a top wall 14 of the case body 1, and the first baffle plate 2 and the baffle cover 3 are both connected to the outer surface of the top wall 14 of the case body 1.

Along the gas exhaust direction S of the gas exhaust channel 11, the gas exhaust channel 11 includes a gas inlet 111 located upstream and a gas outlet 112 located downstream. The gas inlet 111 of the gas exhaust channel 11 is in communication with an inner chamber 5 of the case body 1, the gas outlet 112 of the gas exhaust channel 11 is in communication with an inner cavity 6 of the baffle cover 3, and the gas exhaust channel 11 communicates the inner chamber 5 of the case body 1 with the inner cavity 6 of the baffle cover 3. The first baffle plate 2 is arranged corresponding to the gas outlet 112 of the gas exhaust channel 11, and the first baffle plate 2 is located on one side of the gas outlet 112 away from the gas inlet 111 (for example, when the gas inlet 111 is located on the upper side of the gas outlet 112, the first baffle plate 2 is located on the lower side of the gas outlet 112; when the gas inlet 111 is located on the left side of the gas outlet 112, the first baffle plate 2 is located on the right side of the gas outlet 112 . . . , and so forth).

The baffle cover 3 covers the gas outlet 112 of the gas exhaust channel 11 and the first baffle plate 2, and there is a gas passage 30 between the inner surface of the baffle cover 3 and the first baffle plate 2. The gas outlet 112 of the gas exhaust channel 11 is in communication with the inner cavity 6 of the baffle cover 3. The baffle cover 3 is provided with a gas exhaust opening 321, and the gas exhaust opening 321 is located on one side of the first baffle plate 2 away from the gas inlet 111, so that the gas inside the case body I can be discharged out to the external environment from the gas exhaust opening 321 after flowing sequentially through the gas exhaust channel 11 and the gas passage 30.

In this embodiment, a guiding tab 13 is located inside the case body 1 and obliquely connected to the inner surface of the side wall 12 of the case body 1, and the gas exhaust channel 11 is formed along the guiding tab 13. Specifically, as shown in FIGS. 2 and 6, the guiding tab 13 extends inwardly and upwardly from the inner surface of the side wall 12 of the case body 1 towards the top wall 14 of the case body 1. That is, the guiding tab 13 extends obliquely from the inner surface of the side wall 12 of the case body 1 towards the top wall 14 of the case body 1. The guiding tab 13 has a lower end connected to the inner surface of the side wall 12 of the case body 1 and an upper end pointing towards the top wall 14 of the case body 1. The gas inlet 111 is formed between the upper end of the guiding tab 13 and the inner surface of the side wall 12 of the case body 1, and the gas outlet 112 is defined through the side wall 12 of the case body 1.

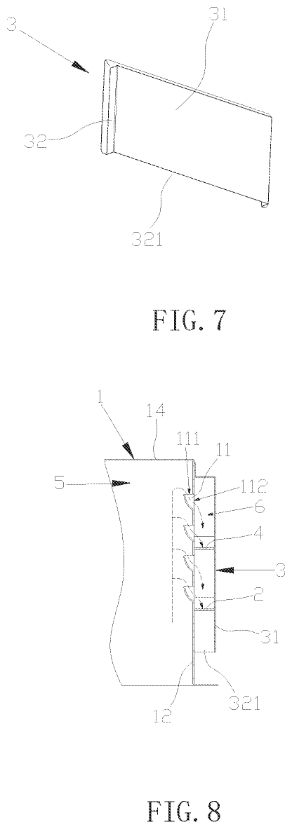

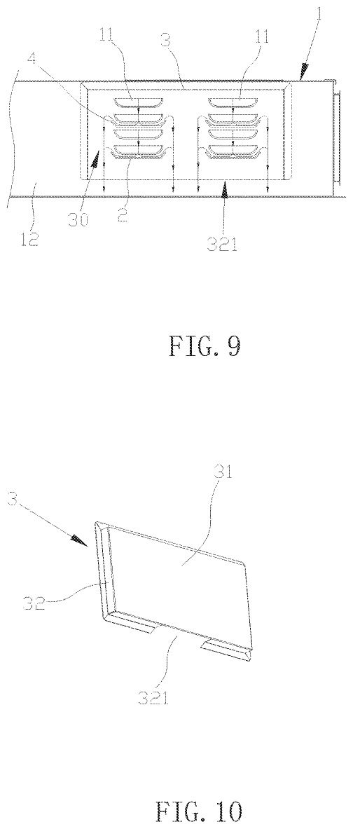

Specifically, as shown in FIGS. 8 and 9, when the gas inside the case body 1 is discharged obliquely from the gas exhaust channel 11, the gas is first obstructed by the first baffle plate 2 and then turns and flows towards the inner surface of the baffle cover 3. Then, the gas is obstructed by the inner surface of the baffle cover 3 and turns to flow through the gas passage 30 between the inner surface of the baffle cover 3 and the first baffle plate 2, and is finally discharged out from the gas exhaust opening 321. The tortuous gas flow channel not only achieves real-time gas exhausting so as to prevent explosion, but also delays the entry of external oxygen. When the battery pack inside the battery case catches fire or explodes due to abnormalities, the gas with flame will rotate and collide with each other when passing through the tortuous gas flow channel, thereby prolonging the flow path of the gas, achieving the goal of consuming oxygen to extinguish the flame, preventing or delaying the flame from escaping, and facilitating the timely transfer of nearby personnel or property.

Specifically, for the battery case provided in the embodiment, the case body 1 is provided with a gas exhaust channel 11, and the gas exhaust channel 11 is arranged obliquely. The first baffle plate 2 and the baffle cover 3 are arranged outside the gas exhaust channel 11. Due to the blockage of the first baffle plate 2 and the baffle cover 3, a tortuous gas flow channel is formed inside the baffle cover 3. The gas inside the case body I can be discharged in real-time through this tortuous gas flow channel to balance the pressure between the inside and outside of the case body 1 and prevent explosion. Further, when the battery pack inside the battery case catches fire or explodes due to abnormalities, it is beneficial to extinguish the flame of the gas having the flame, thereby achieving the goal of preventing or delaying the flame from escaping.

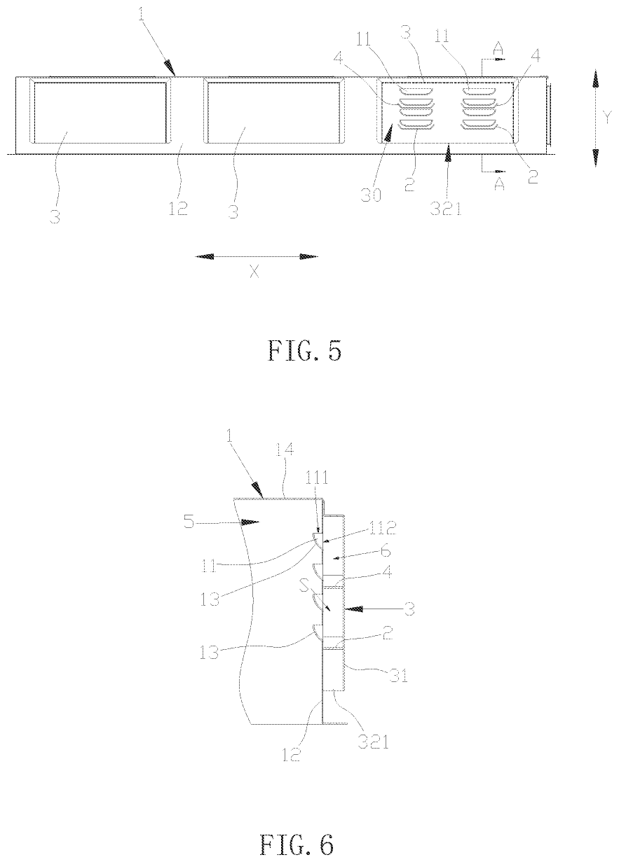

As shown in FIGS. 5 to 7, in one embodiment, the baffle cover 3 includes an outer cover plate 31 and at least one side cover plate 32. The outer surface of the side wall 12 of the case body 1 is spaced from the outer cover plate 31, the side cover plate 32 is connected to the outer cover plate 31, and the outer cover plate 31 is connected to the outer surface of the side wall 12 of the case body 1 through the side cover plate 32. One side of the first baffle plate 2 away from the case body I abuts against the inner surface of the outer cover plate 31. The battery case has a first direction X, wherein the first direction X is perpendicular to the gas exhaust direction S of the gas exhaust channel 11, and the first direction X is parallel to the outer surface of the side wall 12 of the case body 1 on which the first baffle plate 2 is located. Along the first direction X, the gas passage 30 is formed between the inner surface of the side cover plate 32 and the first baffle plate 2.

Therefore, when the gas is discharged, the gas will not directly pass between the first baffle plate 2 and the outer cover plate 31. Instead, the gas needs to turn and flow to the gas passage 30 between the inner surface of the side cover plate 32 and the first baffle plate 2, thus making the flow path of the gas more tortuous, which is conducive to improving the flame extinguishing ability.

As shown in FIG. 7, in one embodiment, the side cover plates 32 are connected to the outer periphery of the outer cover plate 31. Specifically, there are three side cover plates 32, and the three side cover plates 32 are respectively connected to the top side, left side and right side of the outer cover plate 31.

As shown in FIGS. 5 to 7, in one embodiment, the gas exhaust opening 321 is formed on the baffle cover 3 at one side of the gas outlet 112 away from the gas inlet 111 (i.e., no side cover plate 32 is set at the position of the gas exhaust opening 321). Specifically, in this embodiment, no side cover plate 32 is provided at the bottom side of the baffle cover 3 to form the gas exhaust opening 321 at the bottom side of the baffle cover 3, while the top side and two lateral sides of the baffle cover 3 are provided with the side cover plates 32 which are connected to the outer surface of the side wall 12 of the case body 1. Of course, as shown in FIGS. 6 and 10, in other embodiments, the gas exhaust opening 321 may also be formed on the side cover plate 32 that is located at one side of the gas outlet 112 away from the gas inlet 111. Specifically, as shown in FIG. 10, a middle portion of the side cover plate 32 provided at the bottom side of the baffle cover 3 is removed so as to form the gas exhaust opening 321.

As shown in FIGS. 4 and 6, in one embodiment, the battery case has a first direction X, wherein the first direction X is perpendicular to the gas exhaust direction S of the gas exhaust channel 11, and the first direction X is parallel to the outer surface of the side wall 12 of the case body 1 on which the first baffle plate 2 is located. The first baffle plate 2 extends along the first direction X, and two opposite ends of the first baffle plate 2 along the first direction X extend beyond two opposite lateral sides of the gas outlet 112, respectively. Therefore, when the gas is discharged from the gas exhaust channel 11, it is possible for the gas to be deflected as much as possible due to blockage of the first baffle plate 2.

As shown in FIGS. 4 to 6, in one embodiment, the first baffle plate 2 includes a flat portion 21 and two sloping portions 22 connected to the two opposite ends of the flat portion 21. The flat portion 21 extends along the first direction X. The sloping portion 22 is oblique at a certain angle with respect to the first direction X, wherein the angle α formed between the sloping portion 22 and the flat portion 21 is an obtuse angle, and the angle α is located on one side of the first baffle plate 2 near the gas outlet 112. The sloping portion 22 includes a connecting end 221 connected to the flat portion 21 and a protruding end 222 arranged opposite to the connecting end 221. Along the first direction X, the protruding end 222 extends beyond one side of the gas outlet 112.

Specifically, since the first baffle plate 2 abuts against the inner surface of the outer cover plate 31, the gas needs to pass through the gas passage 30 between the first baffle plate 2 and the side cover plate 32. When the gas passes along the first baffle plate 2, the gas will be guided by the sloping portions 22 to be turned and deflected, thereby making the flow path of the gas more tortuous, which is beneficial for improving the flame extinguishing ability.

As shown in FIGS. 4 and 5, in one embodiment, the case body 1 is provided with multiple gas exhaust channel groups 10, and the multiple gas exhaust channel groups 10 are arranged and spaced apart along the first direction X. Each gas exhaust channel group 10 includes one first baffle plate 2 and at least one gas exhaust channel 11. The first baffle plates 2 of adjacent gas exhaust channel groups 10 are spaced apart from each other.

Specifically, since the first baffle plate 2 abuts against the inner surface of the outer cover plate 31, the gas needs to pass through the gas passage 30 between the first baffle plate 2 and the side cover plate 32. In the multiple gas exhaust channel groups 10, adjacent gas exhaust channel groups 10 are spaced apart, and adjacent first baffle plates 2 are also spaced apart. As shown in FIGS. 4 and 9, when the gas is discharged, the gas can pass through the gap between adjacent gas exhaust channel groups 10 and the gap between adjacent first baffle plates 2, which is beneficial for increasing the flow area, thereby improving the performance of gas exhausting and explosion-proof.

In one embodiment, the number of the baffle cover 3 is one or more, and each baffle cover 3 correspondingly covers one gas exhaust channel group 10 or multiple adjacent gas exhaust channel groups 10.

As shown in FIGS. 4 and 5, in one embodiment, the number of the baffle cover 3 is multiple, and each baffle cover 3 correspondingly covers multiple adjacent gas exhaust channel groups 10 (in this embodiment, each baffle cover 3 correspondingly covers adjacent two gas exhaust channel groups 10). Of course, in other embodiments, each baffle cover 3 can also cover only one gas exhaust channel group 10.

As shown in FIGS. 4 to 6, in one embodiment, the battery case has a second direction Y, wherein the second direction Y is perpendicular to the first direction X, and the second direction Y is parallel to the outer surface of the side wall 12 of the case body 1 on which the first baffle plate 2 is located. Each gas exhaust channel group 10 includes multiple gas exhaust channels 11, and the multiple gas exhaust channels 11 in each gas exhaust channel group 10 are sequentially arranged along the second direction Y. Along the gas exhaust direction S of the gas exhaust channel 11, the first baffle plate 2 is arranged at the most downstream gas exhaust channel 11 of the gas exhaust channel group 10, so that the gas discharged from all the gas exhaust channels 11 of the gas exhaust channel group 10 can be blocked by the first baffle plate 2 (in the case of no second baffle plate 4).

As shown in FIGS. 4 to 6, in one embodiment, the gas exhaust channel 11 is provided on the side wall 12 of the case body 1. Along the gas exhaust direction S of the gas exhaust channel 11, the gas exhaust channel 11 is sloped downwards. The multiple gas exhaust channel groups 10 are arranged and spaced apart in a horizontal direction, and each gas exhaust channel 11 extends along the horizontal direction. The multiple gas exhaust channels 11 in each gas exhaust channel group 10 are arranged and spaced apart sequentially in a vertical direction. The first baffle plate 2 is located under the lowest gas exhaust channel 11 in each gas exhaust channel group 10.

As shown in FIGS. 4 and 7, in one embodiment, the battery case further includes a second baffle plate 4. The second baffle plate 4 is arranged between adjacent two gas exhaust channels 11 in the gas exhaust channel group 10. The second baffle plate 4 is connected to the outer surface of the side wall 12 of the case body 1. The inner side of the second baffle plate 4 is connected to the outer surface of the side wall 12 of the case body 1, while the outer side of the second baffle plate 4 away from the case body I abuts against the inner surface of the outer cover plate 31. Specifically, each gas exhaust channel group 10 includes multiple gas exhaust channels 11 spaced apart and arranged along the second direction Y, the second baffle plate 4 is arranged between adjacent two gas exhaust channels 11 in the gas exhaust channel group 10, and the first baffle plate 2 is located below the second baffle plate 4 and arranged under the lowest gas exhaust channel 11 in the gas exhaust channel group 10. Each of the first baffle plate 2 and the second baffle plate 4 extends in the horizontal direction. Further, the gas exhaust opening 321 is located under the first baffle plate 2. Thus, the gas discharged from some of the gas exhaust channels 11 (i.e., the upper gas exhaust channels 11) in the gas exhaust channel group 10 can be obstructed by the second baffle plate 4 to be turned and deflected, thereby reducing the amount of gas flowing to the first baffle plate 2 located under the second baffle plate 4. This not only benefits flame extinguishing, but also relieves the pressure on the first baffle plate 2 and prolongs its service life.

As shown in FIG. 4, in one embodiment, the structure of the second baffle plate 4 is the same as that of the first baffle plate 2.

As shown in FIGS. 1 to 5, in one embodiment, the battery case is in a cuboid structure and has a length direction, a width direction, and a height direction. The first direction X is the length direction of the battery case (of course, in other embodiments, the first direction X may also be the width direction of the battery case), and the second direction Y is the height direction of the battery case.

As shown in FIGS. 4 to 6, in one embodiment, the gas exhaust channel 11 is arranged on the side wall 12 of the case body 1. The first baffle plate 2, the second baffle plate 4 and the baffle cover 3 are all connected to the outer surface of the side wall 12 of the case body 1. Along the gas exhaust direction S of the gas exhaust channel 11, the gas exhaust channel 11 is sloped downwards, the first baffle plate 2 is located under the gas outlet 112 of the gas exhaust channel 11, and the gas exhaust opening 321 is located at the bottom of the baffle cover 3.

Specifically, when a fire breaks out in the battery case, the flame rises. Since the gas exhaust channel 11 is sloped downwards, it is beneficial to prevent or delay the flame from escaping. Also, since the gas exhaust opening 321 is located at the bottom of the baffle cover 3, compared to the structure where the gas exhaust opening 321 is located at the top or lateral sides of the baffle cover 3, it is beneficial to improve the waterproof and dustproof ability of the battery case.

Specifically, the gas inside the case body 1 can flow along the gas exhaust channel 11 to enter the inner cavity 6 of the baffle cover 3, then collide with the first baffle plate 2 and turn towards two opposite ends of the first baffle plate 2, and then flow towards the gas exhaust opening 321, to finally be discharged out from the gas exhaust opening 321.

As shown in FIG. 2, in one embodiment, the side walls 12 on opposite sides of the case body 1 are provided with the gas exhaust channels 11, thus forming a gas exhausting structure on both sides of the battery case. Of course, in other embodiments, the gas exhaust channels 11 may also be set on the side wall 12 at only one side of the case body 1, or on the side walls 12 of more sides of the case body 1.

In one embodiment, the battery case also includes a bottom cover (not shown). An opening (not labelled) is provided at the bottom of the case body 1. The bottom cover is arranged at the bottom opening of the case body 1 and connected to the case body 1 to form a complete battery case.

In the battery case provided in the embodiment of the present application, a gas exhaust channel 11 is provided on the case body 1, the gas exhaust channel 11 is arranged obliquely, and the first baffle plate 2 and the baffle cover 3 are arranged outside the gas exhaust channel 11. Due to the blockage of the first baffle plate 2 and the baffle cover 3, a tortuous gas flow channel is formed inside the baffle cover 3. The gas inside the case body 1 can be discharged in real-time through the tortuous gas flow channel to balance the pressure between the inside and outside of the case body 1 and prevent explosion. It can also prevent or delay the flame from escaping when the battery pack inside the battery case catches fire or explodes due to abnormalities.

The battery case in the embodiment has an gas flow channel that is in direct communication with the external environment. On the one hand, when the battery case is in normal use, the gas flow channel can balance the internal and external gas pressure in real time to prevent deformation of the case body 1 caused by internal and external pressure difference due to factors such as thermal expansion. On the other hand, when the battery pack in the case body 1 produces gas due to failure, the functions of explosion-proof and gas exhausting of the battery case will not be limited by the explosion-proof threshold, and the gas can be discharged to the outside of the battery case as soon as possible, thereby improving explosion-proof performance. Further, the tortuous gas flow channel is conducive to extinguishing flame, thereby preventing or delaying flame escape, and facilitating the timely transfer of nearby personnel or property.

The above are only the specific embodiments of the present application, but the scope of protection of the present application is not limited to this. Any technical personnel familiar with this technical field who can easily think of changes or replacements within the scope of technology disclosed in the present application should be covered within the scope of protection of the present application. Therefore, the protection scope of the present application should be based on the protection scope of the claims.

What is claimed is:

1. A battery case comprising a case body, a first baffle plate and a baffle cover, wherein a gas exhaust channel is obliquely penetrated through a wall of the case body, and the first baffle plate and the baffle cover are both connected to an outer surface of the wall of the case body;
along a gas exhaust direction of the gas exhaust channel, the gas exhaust channel comprises a gas inlet located upstream and a gas outlet located downstream, and the first baffle plate is located on one side of the gas outlet away from the gas inlet;
the baffle cover covers the gas outlet and the first baffle plate, and there is a gas passage between an inner surface of the baffle cover and the first baffle plate; the baffle cover is provided with a gas exhaust opening, and the gas exhaust opening is located on one side of the first baffle plate away from the gas inlet; gas inside the case body is able to be discharged out from the gas exhaust opening after flowing sequentially through the gas exhaust channel and the gas passage.

2. The battery case as claimed in claim 1, wherein the baffle cover comprises an outer cover plate and a side cover plate, the outer surface of the wall of the case body is spaced from the outer cover plate, the side cover plate is connected to the outer cover plate, and the outer cover plate is connected to the outer surface of the wall of the case body through the side cover plate;
one side of the first baffle plate away from the case body abuts against an inner surface of the outer cover plate.

3. The battery case as claimed in claim 2, wherein the battery case has a first direction, wherein the first direction is perpendicular to the gas exhaust direction of the gas exhaust channel, and the first direction is parallel to the outer surface of the wall of the case body on which the first baffle plate is located; along the first direction, the gas passage is formed between an inner surface of the side cover plate and the first baffle plate.

4. The battery case as claimed in claim 1, wherein the battery case has a first direction, wherein the first direction is perpendicular to the gas exhaust direction of the gas exhaust channel, and the first direction is parallel to the outer surface of the wall of the case body on which the first baffle plate is located; along the first direction, two opposite ends of the first baffle plate extend beyond two opposite sides of the gas outlet, respectively.

5. The battery case as claimed in claim 4, wherein along the first direction, the first baffle plate comprises a flat portion and two sloping portions connected to two opposite ends of the flat portion; the flat portion extends along the first direction, and an angle formed between the sloping portion and the flat portion is an obtuse angle, the obtuse angle is located on one side of the first baffle plate near the gas outlet.

6. The battery case as claimed in claim 1, wherein the battery case has a first direction, wherein the first direction is perpendicular to the gas exhaust direction of the gas exhaust channel, and the first direction is parallel to the outer surface of the wall of the case body on which the first baffle plate is located;
the case body is provided with multiple gas exhaust channel groups, the multiple gas exhaust channel groups are arranged and spaced apart along the first direction, each gas exhaust channel group comprises one first baffle plate and at least one gas exhaust channel; the first baffle plates of adjacent gas exhaust channel groups are spaced apart from each other.

7. The battery case as claimed in claim 6, wherein the number of the baffle cover is one or multiple, and each baffle cover correspondingly covers one gas exhaust channel group or multiple adjacent gas exhaust channel groups.

8. The battery case as claimed in claim 6, wherein the battery case has a second direction, wherein the second direction is perpendicular to the first direction, and the second direction is parallel to the outer surface of the wall of the case body on which the first baffle plate is located;
each gas exhaust channel group comprises multiple gas exhaust channels, and the multiple gas exhaust channels in each gas exhaust channel group are sequentially arranged along the second direction; along the gas exhaust direction of the gas exhaust channel, the first baffle plate is arranged at the most downstream gas exhaust channel of the gas exhaust channel group.

9. The battery case as claimed in claim 8, wherein the battery case further comprises a second baffle plate, and the second baffle plate is arranged between adjacent two gas exhaust channels of the gas exhaust channel group.

10. The battery case as claimed in claim 1, wherein the gas exhaust channel is provided on a side wall of the case body, and along the gas exhaust direction of the gas exhaust channel, and the gas exhaust channel is sloped downwards.

11. The battery case as claimed in claim 2, wherein the gas exhaust channel is provided on a side wall of the case body, and along the gas exhaust direction of the gas exhaust channel, and the gas exhaust channel is sloped downwards.

12. The battery case as claimed in claim 3, wherein the gas exhaust channel is provided on a side wall of the case body, and along the gas exhaust direction of the gas exhaust channel, and the gas exhaust channel is sloped downwards.

13. The battery case as claimed in claim 4, wherein the gas exhaust channel is provided on a side wall of the case body, and along the gas exhaust direction of the gas exhaust channel, and the gas exhaust channel is sloped downwards.

14. The battery case as claimed in claim 5, wherein the gas exhaust channel is provided on a side wall of the case body, and along the gas exhaust direction of the gas exhaust channel, and the gas exhaust channel is sloped downwards.

15. The battery case as claimed in claim 6, wherein the gas exhaust channel is provided on a side wall of the case body, and along the gas exhaust direction of the gas exhaust channel, and the gas exhaust channel is sloped downwards.

16. The battery case as claimed in claim 7, wherein the gas exhaust channel is provided on a side wall of the case body, and along the gas exhaust direction of the gas exhaust channel, and the gas exhaust channel is sloped downwards.

17. The battery case as claimed in claim 8, wherein the gas exhaust channel is provided on a side wall of the case body, and along the gas exhaust direction of the gas exhaust channel, and the gas exhaust channel is sloped downwards.

18. The battery case as claimed in claim 9, wherein the gas exhaust channel is provided on a side wall of the case body, and along the gas exhaust direction of the gas exhaust channel, and the gas exhaust channel is sloped downwards.

19. The battery case as claimed in claim 10, wherein the first baffle plate is located under the gas outlet of the gas exhaust channel, and the gas exhaust opening is located at the bottom of the baffle cover.

20. The battery case as claimed in claim 10, wherein a guiding tab is located inside the case body and obliquely connected to an inner surface of the side wall of the case body, and the gas exhaust channel is formed along the guiding tab.
